(19) United States
(12) Patent Application Publication
(10) Pub. No.: US 2009/0079876 A1
(43) Pub. Date: Mar. 26, 2009

(54) IMAGE PROCESSING APPARATUS, METHOD, AND PROGRAM

(76) Inventors: Hidenori TAKESHIMA, Ebina-shi (JP); Toshimitsu Kaneko, Kawasaki-shi (JP); Takashi Ida, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/233,030

(22) Filed: Sep. 18, 2008

(30) Foreign Application Priority Data
Sep. 26, 2007 (JP) 2007-250181

(51) Int. Cl. H04N 5/14

(52) U.S. Cl. 348/699; 348/E05.062

(57) ABSTRACT

An image processing apparatus includes a first receiving unit configured to receive a plurality of frames of an image containing pixel values, a first setting unit configured to set one of the frames as a reference frame, a second setting unit configured to set, of the frames received by the first receiving unit, one frame other than the reference frame as an other frame, a first storage unit configured to store at least one subpixel shift value that is a preset fractional value, and an estimation unit configured to estimate a fractional part of a position of a corresponding point corresponding to a pixel of the other frame to readily select a value closer to the subpixel shift value.

### CROSS-REFERENCE TO RELATED APPLICATIONS

This application is based upon and claims the benefit of priority from prior Japanese Patent Application No. 2007-250181, filed Sep. 26, 2007, the entire contents of which are incorporated herein by reference.

### BACKGROUND OF THE INVENTION

1. Field of the Invention

The present invention relates to an image processing apparatus, method, and program for a motion vector estimation method used to, e.g., obtain a sharp image at a higher resolution from an input image.

2. Description of the Related Art

To maintain the sharpness of an image to be converted into a higher resolution, a method is used which estimates the pixel values of sampling points of non-integer coordinates by searching for corresponding points of a plurality of frames, and obtains the image at the output resolution by integrating the pieces of information. This technique is named super-resolution (e.g., S. C. Park et al., “Super-Resolution Image Reconstruction: A Technical Overview”, IEEE Signal Processing Magazine, pp. 21-36, May 2003). Super-resolution is executed in two steps: registration and image reconstruction, as described in S. C. Park et al., “Super-Resolution Image Reconstruction: A Technical Overview”, IEEE Signal Processing Magazine, pp. 21-36, May 2003.

The performance of registration largely affects the quality of an estimated image. The registration can use any method (e.g., Lucas-Kanade method, Horn-Schunck method, or block matching) if it can obtain corresponding points between frames. However, if a registration error occurs, a high-resolution image degrades, as is known. It is preferable to estimate a motion using a robust motion model considering a plurality of motions, occlusions, and overlay information (e.g., S. C. Park et al., “Super-Resolution Image Reconstruction: A Technical Overview”, IEEE Signal Processing Magazine, pp. 21-36, May 2003).

When a robust motion model is designed, and a global motion is estimated using such model, the sharpness improves upon image reconstruction of a part that matches the model. However, when a large registration error occurs at a part that does not match the model, no expected image is obtained by image reconstruction.

If registration is done under only local restrictions by, e.g., a method of performing quadratic function fitting using pixels that match in block matching in a small area and their neighboring pixels, the registration error is not so large. However, the sharpness does not largely improve when image reconstruction is performed.

The inventors experimentally found that the reason why even local estimation cannot improve the sharpness is present in the aperture problem. In estimating a motion from the first frame to the second frame, it is not possible to uniquely estimate the motion. This problem is called an aperture problem. At a portion where the aperture problem exists, even when a position in the second frame corresponding to a pixel of the first frame is to be calculated, the position to be selected is unknown. The conventional method does not particularly execute arbitrary control. Hence, the position to be selected is determined by the characteristic of the search algorithm.

### BRIEF SUMMARY OF THE INVENTION

In accordance with an aspect of the invention, there is provided an image processing apparatus comprising: a first receiving unit configured to receive a plurality of frames of an image containing pixel values; a first setting unit configured to set one of the frames as a reference frame; a second setting unit configured to set, of the frames received by the first receiving unit, one frame other than the reference frame as an other frame; a first storage unit configured to store at least one subpixel shift value that is a preset real value; and an estimation unit configured to estimate a fractional part of a position of a corresponding point corresponding to a pixel of the other frame to readily select a value closer to the subpixel shift value.

### BRIEF DESCRIPTION OF THE SEVERAL VIEWS OF THE DRAWING

FIG. 1 is a view showing an example in which a motion cannot uniquely be estimated in registration from a frame to the next frame;

FIG. 2 is a view showing an example of ideal sampling points in enlarging an image by twice in the vertical and horizontal directions;

FIG. 3 is a view showing an example in which sampling points close to those of a target image frame itself are obtained;

FIG. 4 is a block diagram of an image processing apparatus according to the embodiment;

FIG. 5 is a view showing an example of higher-resolution image generation using a plurality of frames;

FIG. 6 is a view showing an example of higher-resolution image generation using one frame;

FIG. 7 is a block diagram of the image processing apparatus according to the embodiment different from FIG. 4;

FIG. 8 is a flowchart illustrating an example of the operation of the image processing apparatus shown in FIG. 4 or 7;

FIG. 9 is a view for explaining a first method of obtaining sampling points close to those shown in FIG. 10;

FIG. 10 is a view showing an example of ideal sampling points;

FIG. 11 is a view for explaining a second method of obtaining sampling points close to those shown in FIG. 10;

FIG. 12 is a view for explaining a third method of obtaining sampling points close to those shown in FIG. 10;

FIG. 13 is a view for explaining a search method of obtaining a motion vector of each pixel by global search;

FIG. 14 is a flowchart illustrating a method of controlling the bias of a corresponding point smaller than the quantization width, which is caused by the aperture problem; and

FIG. 15 is a flowchart illustrating an example of global motion optimization or a process of the Lucas-Kanade method.

### DETAILED DESCRIPTION OF THE INVENTION

An image processing apparatus, method, and program according to an embodiment of the present invention will be described below in detail with reference to the accompanying drawing. In the following embodiment, parts having the same reference numerals execute the same operations, and a repetitive description thereof will be omitted.

### (Details of Problem)

A problem will be described in detail.

As described in S. C. Park et al., “Super-Resolution Image Reconstruction: A Technical Overview”, IEEE Signal Processing Magazine, pp. 21-36, May 2003, super-resolution is executed in two steps: registration and image reconstruction in the following way. A frame (reference frame) that is to be magnified to high-resolution image calculation will be referred to as a conversion target frame, and the remaining frames will be referred to as other frames, for the descriptive convenience.

Step 1 (registration): For each pixel of the k-th input frame, a corresponding point in the conversion target frame is searched by registration. The obtained points are used in the next step as new sampling points in the conversion target frame.

Step 2 (image reconstruction): A pixel value at the output resolution of the conversion target frame is represented by

x=[x₁, x₂, . . . , x_{N}]^{T} (1)

A pixel value of a low-resolution image of the input conversion target frame is represented by

y₀[y_{0,1}, y_{0,2}, . . . , y_{0,M}]^{T} (2)

A pixel value of a low-resolution image of the kth input frame is represented by

yₖ[y_{k,1}, y_{k,2}, . . . , y_{k,M}]^{T} (3)

The kth noise is represented by nₖ. Note that, e.g., the luminance value of an image or each of the RGB component values can be handled as a pixel value. A matrix Wₖ that combines the corresponding point information obtained in step 1 with a known camera pixel sampling model down-sampling method is given. Then, an expression to be solved by k=0, 1, . . . is

yₖ=Wₖx+nₖ (4)

This expression includes unknown noise. The existence of Wₖ⁻¹ is also unknown. In super-resolution,

x=[x₁, x₂, . . . , x_{N}]^{T} (5)

is estimated so that Expression (4) is satisfied as much as possible in consideration of the normal characteristic of noise. Many methods are usable for the estimation of x, including ML (Maximum Likelihood) estimation, MAP (Maximum A Posteriori) estimation, POCS (Projection Onto Convex Sets) method, and the iterative back projection method.

The inventors experimentally found that the reason why even local estimation cannot improve the sharpness is present in the aperture problem, to be described next. A problem of estimating the motion from the first frame to the second frame will be examined by using an example shown in FIG. 1. Assume that the boundary line of an object at a position 105 in the first frame moves to a position 101 in the second frame as the object moves. An area that locally matches an area 106 is searched for. Not only one area but many areas as indicated by 102 to 104 exist, and the motion cannot uniquely be estimated. This is the aperture problem. At a portion where the aperture problem exists, even when a position in the second frame corresponding to a pixel of the first frame is to be calculated, the position to be selected is unknown. The conventional method does not particularly execute arbitrary control. Hence, the position to be selected is determined by the characteristic of the search algorithm.

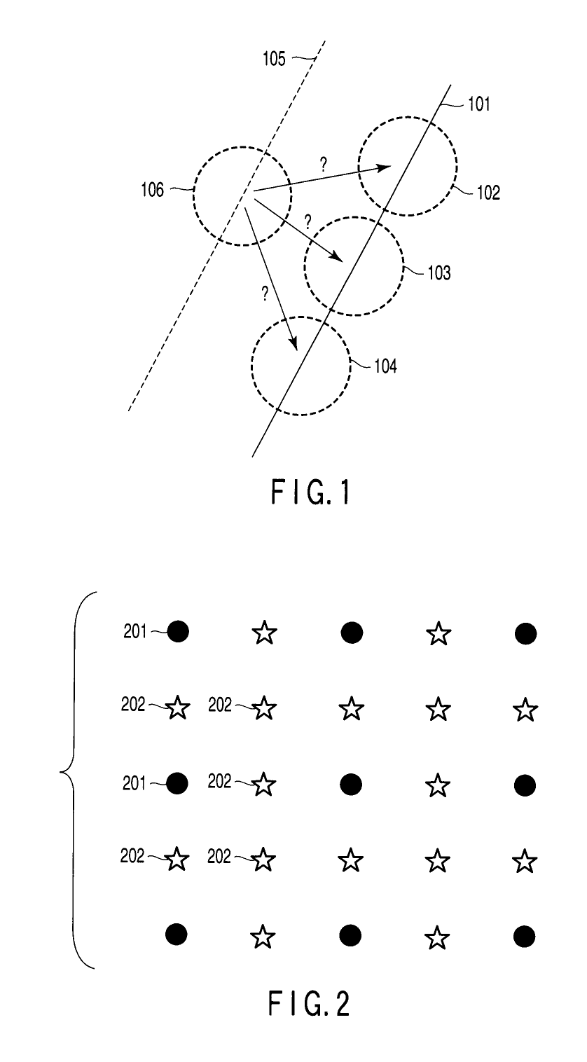

Whether the sharpness can be improved in super-resolution (i.e., a high-frequency component that is missing in a low-resolution image can be reproduced) depends on the sampling points obtained by registration. FIG. 2 shows an example of ideal sampling points in enlarging an image by twice in the vertical and horizontal directions. Reference numeral 201 (filled circle) denotes a sampling point of an image frame itself, which should be subjected to higher-resolution image generation; and 202 (star), a sampling point obtained by registration from another frame. As indicated by 202 in FIG. 2, when the sampling points obtained by estimation are located at the intermediate points between the sampling points, and the interval between the sampling points is equal to or smaller than the reciprocal (in this case, ½) of the scale of magnification, the sampling points are expected to include, at a high probability, information that is necessary for higher-resolution image generation and is used to reproduce missing high-frequency components. When corresponding sampling points in equal number are obtained from another frame, and all the obtained sampling points are close to the sampling points 201 of the image frame itself of the higher-resolution image generation target, they are not expected to include information usable for reproducing missing high-frequency components.

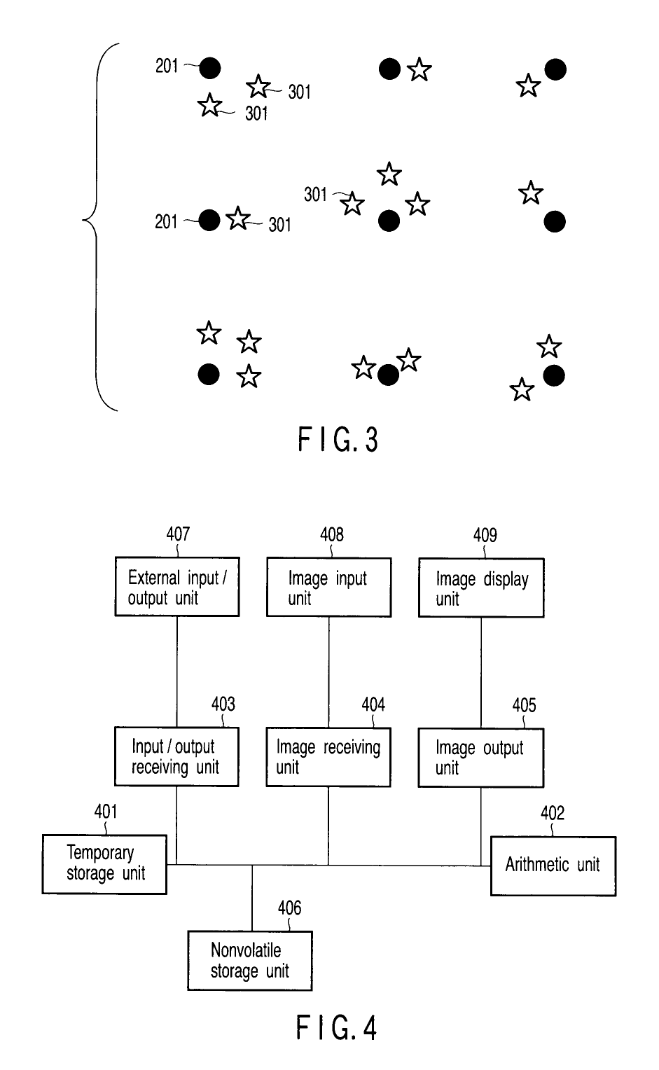

As is apparent from the two cases described above, in the area having the aperture problem, the reproducibility of high-frequency components is determined by whether the search algorithm to be used executes selection close to FIG. 2 or selection close to FIG. 3.

As will be described later, the image quality improving apparatus of this embodiment can avoid the bias of sampling points, as indicated by 301 in FIG. 3 in the area having the aperture problem and reproduce high-frequency components by super-resolution.

For example, consider a method of performing block matching for the displacement of integer pixel positions, executing function fitting using a parametric error function assumed as an error between blocks near the obtained position, and obtaining the minimum position of the error function as a subpixel displacement. Block matching is a method of searching the second frame for an area similar to a template area set in the first frame. More specifically, first, an appropriate search range is set in the second frame. Next, areas having the same shape as that of a template are sequentially extracted from the search range. The sum (to be referred to as a block error hereinafter) of pixel value errors between the template and each extracted area is calculated. An area with the minimum block error is obtained, and a corresponding position is searched for. The template area can be set as, e.g., a square, rectangular, circular, or rhombic area having, at its center, a pixel for which a corresponding sampling point should be obtained (in this embodiment, an area except a rectangular area will also be called a block). The search range can be set by, e.g., defining the template position in the first frame as the center. As the block error, SSD (Sum of Squared Distance: the sum of the squared distances of the pixel values of pixels) or SAD (Sum of Absolute Distance: the sum of the absolute distances of the pixel values of pixels) is usable. When the luminance of a pixel (p,q) at time t is represented by I(p,q,t), and the motion vector of the pixel (p,q) from time t to time t+Δt is represented by (Δp,Δq), SSD and SAD are respectively given by

$$\begin{matrix}S S D = {\sum }_{( p , q ) ∈ block} {( I ( p , q , t ) - I ( p + Δ p , q + Δ q , t + Δ t ) )}^{2} \\ and & ( 6 ) \\ S A D = {\sum }_{( p , q ) ∈ block} \vert I ( p , q , t ) - I ( p + Δ p , q + Δ q , t + Δ t ) \vert & ( 7 )\end{matrix}$$

where block indicates a block to be used for error evaluation in block matching. Function fitting is a method of estimating a subpixel positional shift (estimating a subpixel shift value) based on a block error at a position obtained by block matching and block errors at neighboring positions. More specifically, when SSD is used as a block error, a one-dimensional subpixel positional shift can be calculated, using a quadratic curve as the error function, by

$$S A D = {\sum }_{( p , q ) ∈ block} \vert I ( p , q , t ) - I ( p + Δ p , q + Δ q , t + Δ t ) \vert \qquad ( 8 )$$

(The motion vector after positional shift correction is Δp+subpixel). When SAD is used, a one-dimensional subpixel positional shift can be calculated, using an absolute function as the error function, by

$$subpixel = \{ \begin{matrix}\frac{E ( - 1 ) - E ( 1 )}{2 \{ E ( 1 ) - E ( 0 ) \}} & E ( - 1 ) <= E ( 1 ) \\ \frac{E ( - 1 ) - E ( 1 )}{2 \{ E ( - 1 ) - E ( 0 ) \}} & E ( - 1 ) > E ( 1 )\end{matrix} \qquad ( 9 )$$

where E(i) (i indicates the shift from the minimum position of the motion vector) is the block error at a position corresponding to i. In the above expressions, “<=” indicates “≦” and will be used in the same sense hereinafter. To estimate a two-dimensional subpixel positional shift, for example, the above-described method is applied in both the horizontal and vertical directions. Alternatively, when, e.g., SSD is used, the error function is considered as two-dimensional, and a two-dimensional subpixel positional shift (δx,δy) is assumed to satisfy

aδx²+bδy²+cδxδy+dδx+eδy+f=SSD (10)

For example, the actual measurement values of SSD are given for nine points −1 to +1 as δx and δy, and the least square solutions of coefficients a to f are obtained. Alternatively, six appropriate points are given, and the solutions of the coefficients a to f are obtained. This method allows to estimate (δx,δy) by solving two expressions obtained at partial differentiation=0. Another method has also been proposed, which estimates two-dimensional displacements simultaneously using the expression of one-dimensional subpixel positional shift (e.g., Shimizu and Okutomi, “two-dimensional simultaneous subpixel estimation for area-based matching”, IEICE Transactions D-II, Vol. J87-D-II, No. 2, pp. 554-564, 2004). In the embodiment, for example, the corner detection method of Harris (C. Harris and M. Stephens, “A Combined Corner and Edge Detector”, Alvey Vision Conference, pp. 147-151, 1988) may be used to perform corner determination, although this method is not conventionally used. At a corner portion, the expression of a two-dimensional subpixel positional shift is used. At a portion except a corner, the expression of a one-dimensional subpixel positional shift is used.

As described above, there are many subpixel positional shift estimation methods of obtaining an accurate motion vector. However, these methods strictly assume that no aperture problem arises and do not examine a case with the aperture problem.

When the aperture problem arises, as shown in FIG. 1, a number of positions correspond to a given position. Hence, if block matching is executed in a relatively wide search range, a position having a sufficiently small SSD or SAD value is found at a high probability. If such a position is found, the position obtained by block matching is often already located near the minimum value of the error function. For this reason, a position corrected by a subpixel estimation method is not so largely different from the position obtained by block matching, no matter how accurate the used subpixel estimation method is. Hence, in the widely used method of executing block matching for a displacement of each integer pixel and performing function fitting using the pixels, a position having a sufficiently small error can be found by the block matching executed for a displacement of each integer pixel in a portion having the aperture problem, and corresponding positions concentrate near the found position. Hence, only the sampling points 301 in FIG. 3 are obtained. No sharp image is obtained by super-resolution using these sampling points. This is because, in phraseology of the image processing field, the sampling point interval is larger than the pixel interval of the output resolution in a portion where the aperture problem arises, and reconstruction of high-frequency components of pixel values cannot be expected. Even when not block matching but another method of obtaining a motion of each integer pixel, like the Lucas-Kanade method described in B. D. Lucas and T. Kanade “An Iterative Image Registration Technique with an Application to Stereo Vision”, in Proc. 7th Intl. Joint Conf. on Artificial Intelligence (IJCAI) 1981, Aug. 24-28, pp. 674-679, and the Horn-Schunck method described in B. K. P. Horn and B. G. Schunck, “Determining Optical Flow”, Artificial Intelligence, Vol. 17, pp. 185-203, 1981 is used, the bias of the estimation result in a portion having the aperture problem, as shown in FIG. 3, is hard to completely avoid (although the degree of bias changes depending on the method).

To avoid the bias of sampling points in an area where the aperture problem arises and reproduce high-frequency components by super-resolution, positions close to not FIG. 3 but FIG. 2 are selected when the aperture problem occurs. In other words, a-priori knowledge that a point is selected at a higher probability as the distance from such point to a necessary sampling position becomes shorter is introduced in registration by some method.

According to the image processing apparatus, method, and program of this embodiment, it is possible to avoid the bias of sampling points in an area where the aperture problem arises and reproduce high-frequency components by super-resolution.

### (Term Definition)

As in the background art, a frame that should is magnified to high-resolution image calculation will be referred to as a conversion target frame, and the remaining frames will be referred to as other frames. In this embodiment, note that an intra-frame corresponding point is obtained by handling the conversion target frame in the same way as the other frames, or a plurality of corresponding points are obtained from one of the other frames, unlike the background art.

### (Basic Idea)

As described above, in a region having the aperture problem, the bias shown in FIG. 3 readily occurs without any measure. FIG. 3 shows an example in which block matching is executed for each integer pixel, and the sampling points are corrected by function fitting. The type of bias changes depending on the method. However, since the positions are indefinite due to the aperture problem, the phenomenon that a corresponding point (=sampling point) is located not at a necessary position but at another position is inevitable more or less.

As the basic idea, the embodiment has come up with a new registration method of satisfying following conditions A and B as much as possible. Using the method, sampling points necessary in super-resolution are obtained in an area where the aperture problem arises.

Condition A: A desirable subpixel positional shift for an indefinite position is given in advance. If a position is indefinite due to the aperture problem, the position to be selected as a sampling point is set as close as possible to the given position (a-priori knowledge is introduced by some method to easily select the position).

Condition B: Sampling point control cannot be done in an area having no aperture problem. In this case, the influence of the introduced a-priori knowledge is suppressed as much as possible (setting is done to readily select a correct position).

It is difficult to simultaneously satisfy the conditions A and B to introduce the a-priori knowledge. However, the influence of the introduced a-priori knowledge can be made small. A detailed example of the method of readily selecting a desired sampling point will be described later (the method changes depending on the registration method to be used).

A method of performing super-resolution using the method of readily selecting a desired sampling point will be described first.

In the conventional idea, a sampling point usable in the conversion target frame is obtained by estimating a motion from another frame to the conversion target frame. In this embodiment, however, if another frame and the conversion target frame have corresponding portions, the motion need not always be accurate. For example, a graphic pattern such as a straight line including a lot of congruent blocks has the aperture problem. In this case, instead of obtaining a motion as accurately as possible, a motion in which sampling points usable and convenient for super-resolution are close to those shown in FIG. 2 is found, assuming that any motion can be used without adverse effect in the area with the aperture problem.

### (Overall Procedure of Super-Resolution)

The image processing apparatus of this embodiment, including image reconstruction, will be described next with reference to FIG. 4.

The image processing apparatus of this embodiment includes a temporary storage unit 401, arithmetic unit 402, input/output receiving unit 403, image receiving unit 404, image output unit 405, nonvolatile storage unit 406, external input/output unit 407, image input unit 408, and image display unit 409, as shown in FIG. 4. FIG. 4 shows an example in which the image processing apparatus is implemented by software using a general-purpose arithmetic apparatus.

The temporary storage unit 401 stores one or more image frames. The temporary storage unit 401 also stores one or more preset subpixel positional shifts (subpixel shifts). The subpixel shifts are represented by subpixel shift values which are real values.

The arithmetic unit 402 shifts a pixel of interest in correspondence with a subpixel positional shift, estimates a sampling point in the conversion target frame corresponding to the pixel of interest, sets the pixel value of the pixel of interest corresponding to the estimated sampling point as the pixel value of the estimated sampling point, and calculates the pixel value at the output resolution assuming that at each estimated sampling point, the vector product between the pixel value at the output resolution and the weighting factor vector of a point spread function for calculating a low-resolution pixel value from a high-resolution pixel value corresponding to the output resolution equals the pixel value of the estimated sampling point.

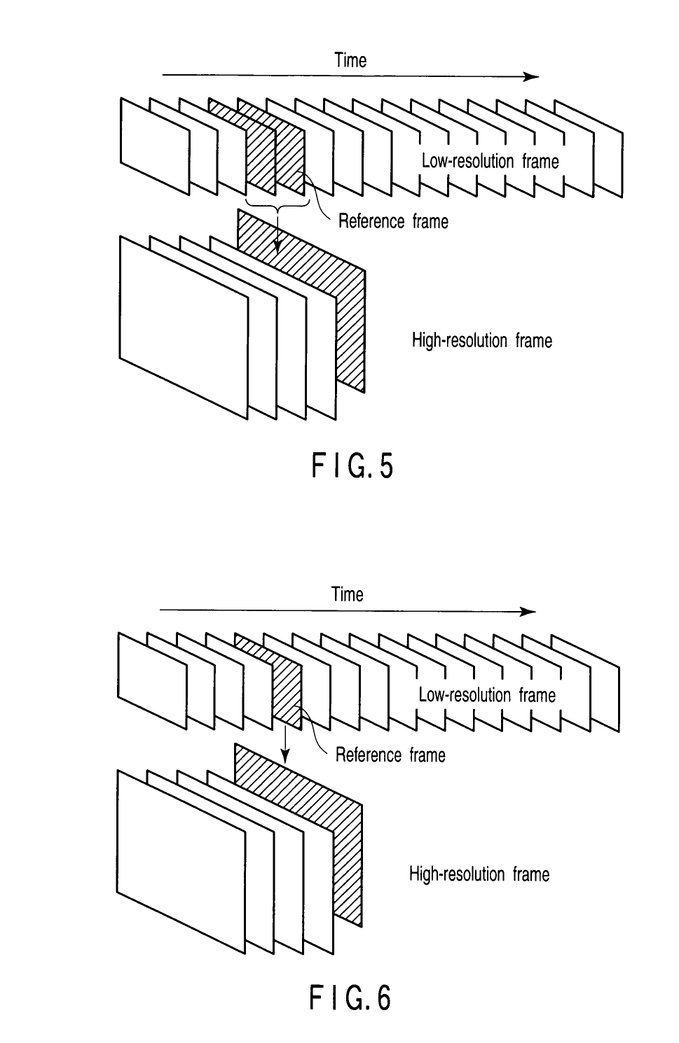

More specifically, the arithmetic unit 402 executes the following arithmetic processes. The arithmetic unit 402 sets, as the conversion target frame, one of the image frames stored in the temporary storage unit 401. The arithmetic unit 402 also sets, as other frames, one or more frames stored in the temporary storage unit 401, except the frame set as the conversion target frame. If image processing is to be executed using one frame, the conversion target frame and the other frame are identical. The image processing apparatus of this embodiment generates a super-resolution image in, e.g., a chronological order using a received low-resolution frame. In FIG. 5, a higher-resolution image generation apparatus generates the fifth high-resolution frame. A low-resolution frame which is being magnified to the higher-resolution image generation process, i.e., the fifth frame in this example will be referred to as a reference frame. To convert the reference frame to a high-resolution frame, two of the low-resolution frames in FIG. 5, i.e., the reference frame and the frame of the immediately preceding time are used. Referring to FIG. 6, the higher-resolution image generation apparatus generates a high-resolution frame using only the low-resolution frame corresponding to the reference frame. For a still image, only one low-resolution image is input. This image corresponds to the reference frame, and a high-resolution image is generated using only that frame. A still image will be expressed as one frame for convenience.

The arithmetic unit 402 defines a set (pixel-of-interest set) of positions where a motion from the other frame of interest to the conversion target frame is to be obtained. The set includes, e.g., all pixels of the other frame of interest. Alternatively, the set includes all pixels in an area obtained by segmenting the other frame of interest at appropriate intervals. An edge detection filter (e.g., Sobel filter) may be applied to the other frame of interest to obtain pixels having a predetermined size or more, and the obtained pixels and neighboring pixels may be included in the pixel-of-interest set. A neighboring pixel indicates a pixel spaced apart from an obtained pixel by a predetermined distance or less. The distance from an image is obtained by, e.g., an L1 distance, L2 distance, or L∞ distance.

The arithmetic unit 402 executes, for each subpixel positional shift, registration with a bias to a subpixel positional shift of interest in an area having the aperture problem and obtains a corresponding position in the conversion target frame from the pixel-of-interest set. A position in the conversion target frame corresponding to each pixel of interest will be referred to as an estimated sampling point. The arithmetic unit 402 searches for a corresponding position while accessing the temporary storage unit 401.

The arithmetic unit 402 sets, for each estimated sampling point, a point spread function that is the weighted function of the pixel value at the output resolution while accessing the temporary storage unit 401. The point spread function sets a pixel-of-interest area determined by, e.g., the input and output resolutions and the image sampling model.

The arithmetic unit 402 sets, as the pixel value of each estimated sampling point, the pixel value of a corresponding pixel of interest. The arithmetic unit 402 executes image reconstruction at each estimated sampling point and calculates an output image. An expression representing that the vector product between the weighting factor vector of the point spread function and the pixel value at the output resolution given by

x=[x₁, x₂, . . . , x_{N}]^{T} (11)

equals the pixel value at the estimated sampling point can be put into a matrix

yₖ=Wₖx (12)

An unknown noise vector given by

nₖ=[n_{k,1}, n_{k,2}, . . . , n_{k,M}]^{T} (13)

is added to Expression (12). Then, the expression to be satisfied by the pixel value at the output resolution can be represented by

yₖ=Wₖx+nₖ (14)

Image reconstruction, e.g., the MAP method or POCS using the expression enables to calculate an output image.

The external input/output unit 407 inputs a program and external parameters (e.g., output resolution) to be used for the arithmetic process of the arithmetic unit 402, or outputs an output image obtained by image reconstruction. The input/output receiving unit 403 receives the program and external parameters input via the external input/output unit 407 and stores them in the temporary storage unit 401.

The image input unit 408 acquires a low-resolution frame as an input image and transfers it to the image receiving unit 404. The image receiving unit 404 receives the input image from the image input unit 408 and transfers it to the temporary storage unit 401. The image output unit 405 acquires a super-resolution image generated by the arithmetic unit 402 and transfers it to the image display unit 409. The image display unit 409 displays the super-resolution image acquired by the image output unit 405.

The nonvolatile storage unit 406 defines sets of subpixel positional shifts to be considered in other frames that are being processed. The sets include, e.g., four sets (0,0), (0,0.5), (0.5,0), and (0.5,0.5). Different sets may be set for the respective shifts. The temporary storage unit 401 may store them. The arithmetic unit 402 receives the subpixel positional shift sets and uses them for the arithmetic process.

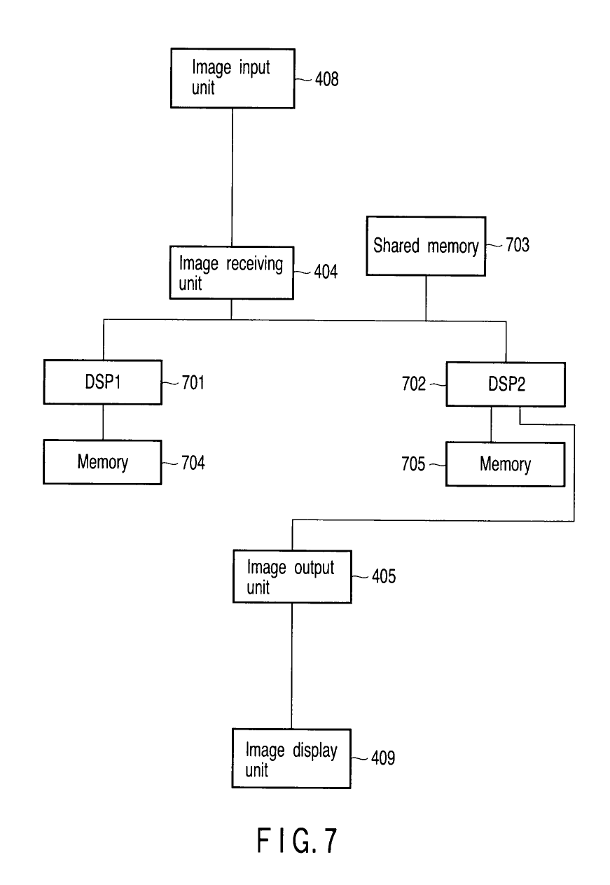

An example in which the image processing apparatus of this embodiment is implemented by circuits will be described next with reference to FIG. 7.

The image processing apparatus shown in FIG. 7 includes a DSP1 701, DSP2 702, shared memory 703, memories 704 and 705, image receiving unit 404, image input unit 408, image output unit 405, and image display unit 409.

The DSP1 701 searches for a corresponding position while accessing the shared memory 703 and writes the result in the shared memory 703. If the access speed decreases in use of, e.g., the shared memory 703, the memory 704 is used as a work area. For example, if block matching should be executed, a block serving as a template and the pixel values in the search range in the other frame are copied in the work area. Searching for the corresponding position is done in the memory 704.

The DSP1 701 gives a desired output resolution and inputs the conversion target frame, or sets the conversion target frame in a given image. The DSP1 701 inputs one or more other frames. The DSP1 701 inputs the set of subpixel positional shifts which are stored in the memory 704 in advance and should be considered in other frames that are being processed. The DSP1 701 defines a set (pixel-of-interest set) of positions where a motion from the other frame of interest to the conversion target frame is to be obtained. The DSP1 701 executes registration with a bias to a subpixel positional shift of interest in an area having the aperture problem and obtains a corresponding position in the conversion target frame from the pixel-of-interest set.

The DSP2 702 sets a point spread function using the result written in the shared memory 703. The DSP2 702 sets, for each estimated sampling point, a point spread function that is the weighted function of the pixel value at the output resolution. The DSP2 702 sets, as the pixel value of each estimated sampling point, the pixel value of a corresponding pixel of interest. The DSP2 702 defines, for each estimated sampling point, an expression representing that the vector product between the weighting factor vector of the point spread function and the pixel value at the output resolution equals the pixel value at the estimated sampling point, adds an unknown noise vector to the expression, and executes image reconstruction using the expression.

The image input unit 408 acquires a low-resolution frame as an input image. The image receiving unit 404 receives the input image from the image input unit 408. The shared memory 703 stores one or more received image frames.

The memories 704 and 705 are dedicated to the DSP1 701 and DSP2 702, respectively, and store programs or data to be used for their arithmetic processes.

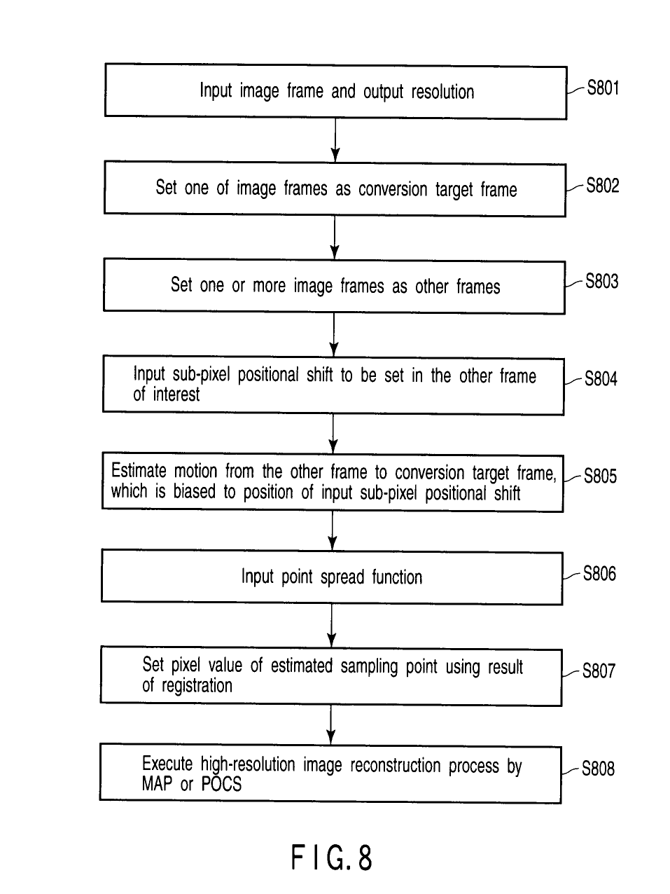

An example of the operation of the image processing apparatus of this embodiment will be described next with reference to FIG. 8.

Step 1 (S801 and S802): The arithmetic unit 402 or DSP1 701 gives a desired output resolution and inputs a conversion target frame, or sets a conversion target frame for a given image.

Step 2 (S803): The arithmetic unit 402 or DSP1 701 inputs one or more other frames. The other frame may be the conversion target frame itself. The other frames and conversion target frame need not always have the same resolution. For example, at least one of the image frames stored in the preceding step is set as the other frame.

Step 3: The following operation is executed for each of the other frames.

Step 3-1 (S804): The arithmetic unit 402 or DSP1 701 inputs sets of subpixel positional shifts (subpixel shift values) which are stored in the memory 704 or nonvolatile storage unit 406 and should be considered in the other frame of interest that is being processed. The sets include, e.g., four sets (0,0), (0,0.5), (0.5,0), and (0.5,0.5). Different sets may be set for the respective shifts. Such parameters can be given in advance as, e.g., the program or data (stored in, e.g., the memory 704) of the DSP1 701 or the data of the temporary storage unit 401 or nonvolatile storage unit 406.

Step 3-2 (S805): The arithmetic unit 402 or DSP1 701 defines a set (pixel-of-interest set) of positions where a motion from the other frame of interest to the conversion target frame is to be obtained. The set includes, e.g., all pixels of the other frame of interest. Alternatively, the set includes all pixels in an area obtained by segmenting the other frame of interest at appropriate intervals. An edge detection filter (e.g., Sobel filter) may be applied to the other frame of interest to obtain pixels having a predetermined size or more, and the obtained pixels and neighboring pixels may be included in the pixel-of-interest set. A neighboring pixel indicates a pixel spaced apart from an obtained pixel by a predetermined distance or less. The distance from an image is obtained by, e.g., an L1 distance, L2 distance, or L∞ distance.

Step 3-3 (S805): The arithmetic unit 402 or DSP1 701 executes, for each subpixel positional shift (subpixel shift value), registration with a bias to a subpixel positional shift of interest in an area having the aperture problem and obtains a corresponding position in the conversion target frame from the pixel-of-interest set. A position in the conversion target frame corresponding to each pixel of interest will be referred to as an estimated sampling point. In FIG. 4, for example, the arithmetic unit 402 searches for a corresponding position while accessing the temporary storage unit 401.

Step 4 (S806): The arithmetic unit 402 or DSP2 702 sets, for each estimated sampling point, a point spread function that is the weighted function of the pixel value at the output resolution. The point spread function sets a pixel-of-interest area determined by, e.g., the input and output resolutions and the image sampling model.

Step 5 (S807): The arithmetic unit 402 or DSP2 702 sets, as the pixel value of each estimated sampling point, the pixel value of a corresponding pixel of interest.

Step 6 (S808): The arithmetic unit 402 or DSP2 702 defines, for each estimated sampling point, an expression representing that the vector product between the weighting factor vector of the point spread function and the pixel value at the output resolution equals the pixel value at the estimated sampling point, adds an unknown noise vector to the expression, and executes image reconstruction using the expression. The MAP method or POCS enables to calculate an output image. The obtained result is sent to the image output unit 405.

If the resolution of the other frame is different from that of the conversion target frame, the pixel sampling model changes. In accordance with the change of the sampling model, the point spread function is changed.

Each of the conversion target frame and other frames can include one frame of a moving image or a plurality of still images taken by a plurality of cameras. Even when one still image is input, the input still image can be set as the conversion target frame and other frames.

A method of obtaining usable sampling points close to those shown in FIG. 2 will be described next. Three methods will be described here.

### (First Method: Method of Applying Bias is Used to Shift Phase of a Plurality of Frames)

Assume that three frames are usable as the other frames. To obtain usable sampling points close to those in FIG. 2, the three other frames are shifted to

(nₓ+0.5,n_{y}),(nₓ,n_{y}+0.5),(nₓ+0.5,n_{y}+0.5) (15)

(where nₓ and n_{y} are integers)

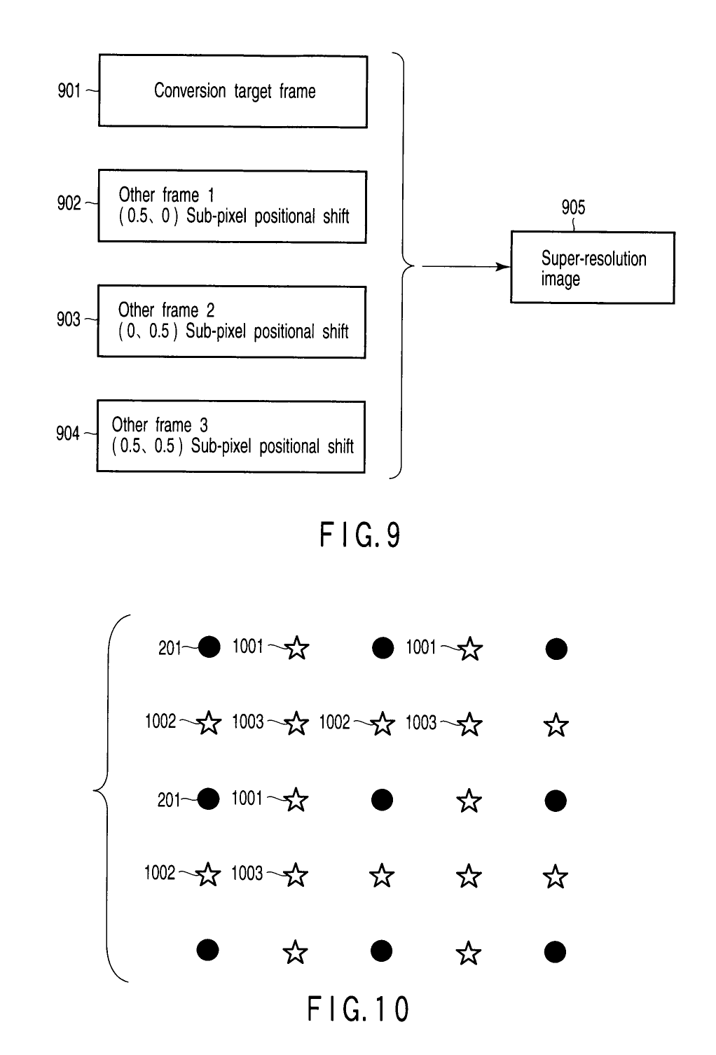

as shown in FIG. 9. The fractional values given as biases are subpixel positional shifts. At this time, in an area having the aperture problem, as shown in FIG. 10, except the sampling points 201 of the conversion target frame, sampling points are found at positions given by

(nₓ+0.5,n_{y}),(nₓ,n_{y}+0.5),(nₓ+0.5,n_{y}+0.5) (16)

i.e., positions close to 1001, 1002, and 1003 in FIG. 10. These sampling points are convenient for increasing the resolution by super-resolution. In this example, magnification by about twice is conveniently executed in the vertical and horizontal directions. Even at a higher scaling factor, missing high-frequency components are reconstructed at a higher probability than in the conventional method. The subpixel positional shift of a sampling point need not always be 0.5, and the sampling points need not exist at equal intervals. For example, to increase only the horizontal resolution using three frames as the other frames,

(nₓ+0.3,n_{y}),(nₓ+0.7,n_{y}),(nₓn_{y}) (17)

may be calculated. The number of frames usable as the other frames need not be three.

### (Second Method: Method of Applying Bias is Used to Use a Plurality of Phases of a Plurality of Frames)

As another method of obtaining usable sampling points close to those in FIG. 2, a motion biased to

(nₓ,n_{y}),(nₓ+0.5,n_{y}),(nₓ,n_{y}+0.5),(nₓ+0.5,n_{y}+0.5) (18)

(where nₓ and n_{y} are integers)

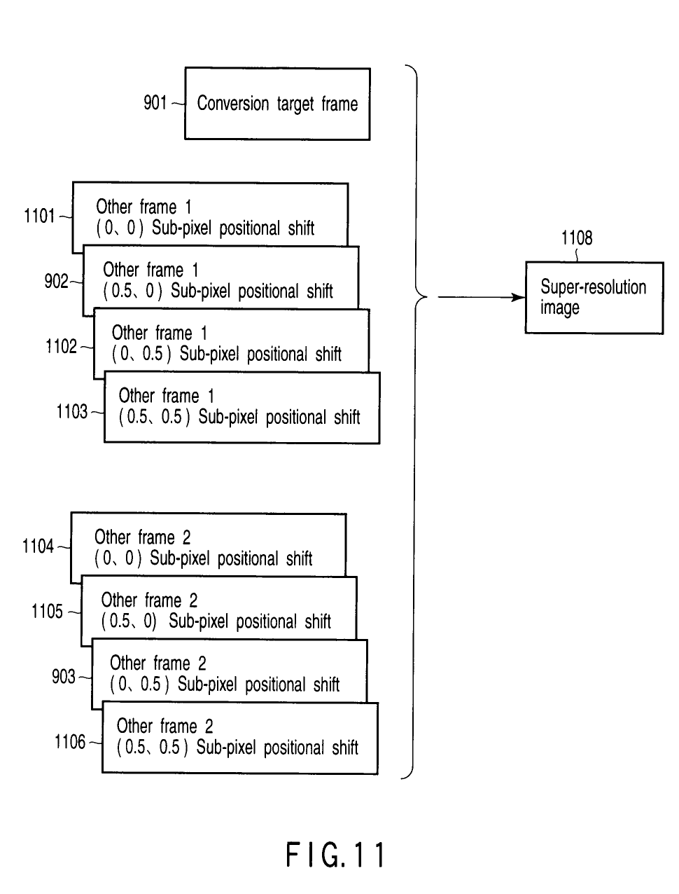

is calculated for each of the other frames, as shown in FIG. 11. By controlling the subpixel positional shift, it is expected that another sampling point can be obtained in an area having the aperture problem, and the same sampling point can be obtained in an area having no aperture problem. At this time, in an area having the aperture problem, sampling points of four frames are obtained even when there is only one other frame. In an area having the aperture problem, sampling points are obtained at positions close to 1001, 1002, and 1003 in FIG. 10 independently of the number of other frames. Even when the number of other frames is two or more, a bias can be applied to the motion of each frame, as shown in FIG. 11. As in the above-described example, the subpixel positional shift of a sampling point need not always be 0.5, and the sampling points need not exist at equal intervals.

### (Third Method: Method of Applying Bias is Used to Use a Plurality of Phases in Frame)

In an area where the aperture problem arises, using the fact that the conversion target frame itself has a congruent graphic pattern, a motion from the conversion target frame to the conversion target frame itself may be obtained to execute super-resolution solely in the conversion target frame. As a further method of obtaining usable sampling points close to those in FIG. 2, a motion from the conversion target frame to the conversion target frame is obtained for a position where, e.g., the subpixel positional shift is given by

(nₓ+0.5,n_{y}),(nₓ,n_{y}+0.5),(nₓ+0.5,n_{y}+0.5) (19)

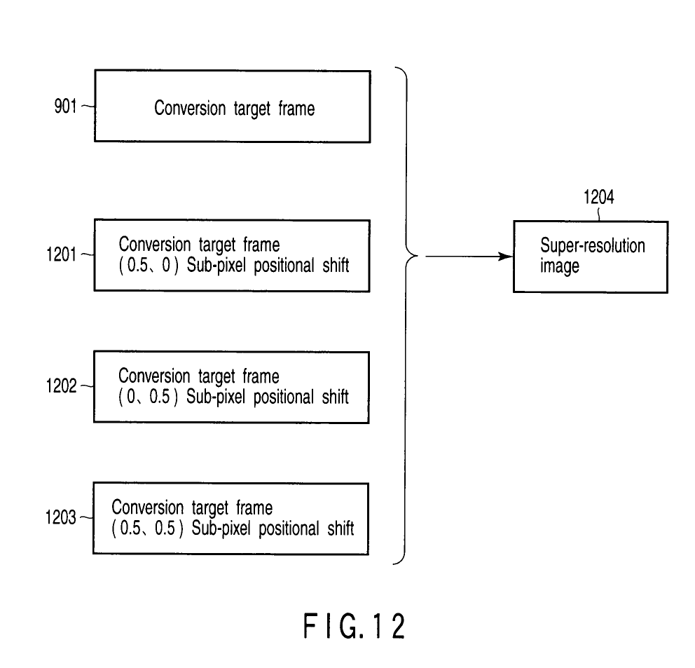

as shown in FIG. 12. Not to obtain the correspondence relationship with respect to the target pixel itself, i.e., the correspondence relationship of the motion (0,0) from the conversion target frame to the conversion target frame itself, the correspondence with respect to the conversion target frame itself is preferably removed in registration by using some method (e.g., in executing registration using block matching, collation for a block of the conversion target frame itself is prohibited, or a motion vector for which the difference vector between the obtained motion and the motion vector (0,0) has a magnitude of a predetermined value or less is removed) (However, removal of a motion vector to the conversion target frame itself is optional). When this method is used for the conversion target frame, any one of the above-described methods may also be used.

Image reconstruction will be described next. (POCS)

For image reconstruction, the method described in S. C. Park et al., “Super-Resolution Image Reconstruction: A Technical Overview”, IEEE Signal Processing Magazine, pp. 21-36, May 2003 is usable. For example, image reconstruction can successively be executed using the following method.

First, a temporary pixel value is given to each pixel of a high-resolution image by applying, e.g., a cubic convolution method to the conversion target frame (The temporary pixel value in the high-resolution image will be referred to as a temporary pixel value). At each pixel position of a low-resolution image, a sampling value (to be referred to as a temporary sampling value) using the corresponding temporary pixel value in the high-resolution image is calculated. A pixel value represents the luminance distribution of a rectangle which is obtained by segmenting the screen into a plurality of rectangles in accordance with the sampling interval. The pixel value is assumed to be located at the center of a rectangle. The pixel density determines the ratio of the rectangle size of an input image to that of an output image. For example, when the resolution decreases to ½ in the vertical and horizontal directions, the rectangle size doubles in the vertical and horizontal directions. When a temporary pixel value is given to each pixel of the corresponding high-resolution image, the temporary sampling value of a corresponding pixel of the low-resolution image is obtained by calculating the weighted average of the temporary pixel values in the high-resolution image used for sampling the pixel values of the low-resolution image. If the high-resolution image is accurate, a pixel value taken as the low-resolution image matches the temporary sampling value. However, they do not match in many cases. To make them close to each other, the temporary pixel value in the high-resolution image is updated. The difference between the temporary sampling value and the pixel value in the low-resolution image is obtained. Each temporary pixel value in the high-resolution image is increased or decreased to reduce the difference. The high-resolution image has a plurality of corresponding pixel values. Hence, the difference is divided based on the weight used upon sampling and added to or subtracted from each pixel value. The addition or subtraction makes the pixel value and temporary sampling value closer to each other for a pixel in the low-resolution image, which has undergone the calculation. For another pixel in the low-resolution image, the difference between the pixel value and the temporary sampling value may be increased by the addition or subtraction. However, the difference between the pixel value and the temporary sampling value can be reduced in many cases by executing this operation for a lot of pixels, as is empirically known. In super-resolution, this operation is performed for the entire low-resolution image an independently determined number of times, and the obtained temporary pixel values in the high-resolution image are output.

The operation of image reconstruction is equivalent to approximately solving

y=Wx+n (20)

There are many variations of the addition/subtraction method in image reconstruction. For example, image reconstruction using POCS is executed in accordance with the following sequence. For example, the arithmetic unit 402 or DSP1 701 executes the following process.

Step 1: A transformation matrix W from a low resolution to a high resolution is given, and an expression y=Wx is set without taking noise into consideration. W is defined by each pixel value of the conversion target frame, corresponding points from other frames to the conversion target frame, the pixel values of the other frames corresponding to the corresponding points, and a point spread function that is a function for calculating each low-resolution pixel value from the high-resolution pixel value. The expression y=Wx without considering noise includes a matrix notation formed by arraying equalities representing that a low-resolution pixel value equals the weighted sum of high-resolution pixel values. The weight of the weighted sum is given in consideration of the image sensing system and the positional relationship between the low-resolution pixel values and the high-resolution pixel values. For, e.g., a high-resolution pixel grid, a weight value using, as a coefficient, a Gaussian distribution having a separately defined dispersion can be set about a position as the center where the center of low-resolution pixels is placed.

Step 2: For the ith pixel, each expression included in y=Wx can be written as

y[i]=W[i]x (21)

where y[i] is the scalar value, W[i] is a horizontal vector obtained by arranging weights, and x is a vertical vector obtained by arranging high-resolution pixel values. In POCS, to obtain x that satisfies

y[i]=W[i]x (22)

without a large influence of noise, a step size β[i] and a constant δ[i] are separately given, and the following repetitive operation is executed. Note that

\hat{x} (23)

indicates the estimated value of x.

$$\hat{x} ← \{ \begin{matrix}\hat{x} + β [ i ] ( y [ i ] - W [ i ] \hat{x} + δ [ i ] ) & if y [ i ] - W [ i ] \hat{x} + δ [ i ] < 0 \\ \hat{x} + β [ i ] ( y [ i ] - W [ i ] \hat{x} - δ [ i ] ) & if y [ i ] - W [ i ] \hat{x} - δ [ i ] > 0 \\ \hat{x} & otherwise\end{matrix} \qquad ( 24 )$$

The step size β[i] and constant δ[i] can either be the same (e.g., β[i]=1, and δ[i]=10) for all values or change depending on the pixel, as is represented by

β[i]=1/∥W[i]∥² (25)

Note that the initial value given by

\hat{x} (26)

is given by applying linear interpolation or a cubic convolution method to the conversion target frame.

Step 3: Step 2 is repeated an independently defined number of times.

Step 4: The obtained estimated high-resolution image given by

\hat{x} (27)

is output.

The sequence of image reconstruction using POCS has been described above. For example, the arithmetic unit 402 or DSP1 701 executes the following process.

Image reconstruction using the MAP method is executed in accordance with the following sequence.

Step 1: y=Wx is set in the same way as in POCS.

Step 2: Consider an energy function which combines a first term representing that the energy increases as the error with respect to the equality y=Wx becomes large, and a second term representing that the energy increases as the error of the image x with respect to the general characteristic of a natural image prepared in advance becomes large. The image x for minimizing the function is searched for. For example, as the general characteristic of a natural image, assume that the luminance values of neighboring pixels do not largely vary. In this case, an expression represented by

$$E = {‖ y - Wx ‖}_{1} + {\sum }_{m} {λ}_{m} {‖ x - {P}_{m} x ‖}_{1} \qquad ( 28 )$$

can be set as the energy function. In this expression, “1” on the lower right side of the norm is the L1 norm, λₘ is the weight for the second term, Pₘ is the matrix representing translation, and m is a considered variation of translation. For example, Pₘ is assumed to include

P₁: horizontal translation

P₂: vertical translation

The second term has a value obtained by calculating the sum of the magnitudes of shifts of adjacent pixels in each of the vertical and horizontal directions and weighting the sums by λ₁ and λ₂.

As a method of minimizing E, for example, a steepest descent method is usable. In the steepest descent method, an operation of advancing the estimated value of x given by

\hat{x} (29)

by a step of −β times in the direction of the slope of the energy function is repeated. This update is done by

$$\hat{x} ← \hat{x} - β \{ {W}^{T} sign ( Wx - y ) + {\sum }_{m} {{λ}_{m} ( I - {P}_{m} )}^{T} sign ( x - {P}_{m} x ) \} \qquad ( 30 )$$

The expression may directly be executed.
Alternatively, the update expression may sequentially be applied to each line of

W^{T}sign(Wx−y) (31)

and each line of

λₘ(I−Pₘ)^{T}sign(x−Pₘx) (32)

as an expression constituting the slope direction of the energy function (by removing expressions other than an expression of interest from the slope term), thereby successively updating the estimated value given by

\hat{x} (33)

Note that the initial value of

\hat{x} (34)

is given by applying linear interpolation or a cubic convolution method to the conversion target frame.

Step 3: Step 2 is repeated an independently defined number of times.

Step 4: The obtained estimated high-resolution image given by

\hat{x} (35)

is output.

The above-described energy function of the MAP method is merely an example and is not limited to this energy function.

How to actually perform calculations in the methods of obtaining usable sampling points close to those shown in FIG. 2, which have been described with reference to FIGS. 9 to 12, will be described next using the following three examples.

### (Method of Facilitating Selection of Desired Sampling Point)

As is apparent from the above-described examples, conversion to a high resolution can effectively be done using a method of facilitating selection of a desired sampling point. The method of facilitating selection of a desired sampling point will be described next.

### EXAMPLE 1

### Block Matching SSD

A method will be examined, in which using an Lα error as a block error function, which is given by

$${D}_{α} = {\sum }_{( p , q ) ∈ block} {\vert I ( p , q , t ) - I ( p + Δ p , q + Δ q , t + Δ t ) \vert}^{α} \\ ( where α is a real number ) \qquad ( 36 )$$

or a robust error using a robust function ρ, which is given by

$${D}_{ρ} = {\sum }_{( p , q ) ∈ block} ρ ( \vert I ( p , q , t ) - I ( p + Δ p , q + Δ q , t + Δ t ) \vert ) \qquad ( 37 )$$

a position where the error value (the value of the Lα error or robust error) is minimized is obtained by block matching, and the shift of fractional accuracy is obtained by function fitting. Note that SSD and SAD correspond to Lα errors when α=2, and α=1, respectively. As the robust function ρ, for example, Huber's robust function given by

$$ρ ( u ) = \{ \begin{matrix}{u}^{2} & \vert u \vert \leq c \\ 2 c \vert u \vert - {c}^{2} & \vert u \vert > c\end{matrix} \qquad ( 38 )$$

is used. A function obtained by setting an upper limit for, e.g., a SAD function, as is given by

$$ρ ( u ) = \{ \begin{matrix}\vert u \vert & \vert u \vert \leq c \\ c & \vert u \vert > c\end{matrix} \qquad ( 39 )$$

is also usable. As the robust function ρ, a function described in C. V. Stewart, “Robust Parameter Estimation in Computer Vision”, SIAM Review, Vol. 41, No. 3, pp. 513-537 may be used. A multidimensional color space such as an RGB color space, CMYK color space, or L*u*v* color space may be converted into a one-dimensional space by, e.g., projecting the color space to a one-dimensional space. For example, an RGB color space is projected by 0.299R+0.587G+0.114B. Alternatively, the sum, weighted sum, or maximum value of error values in each dimension may be used.

Block matching for obtaining a block in the second frame corresponding to a block set in the first frame is executed by, e.g., the following steps. This method associates a block in the first frame with a block in the second frame. In obtaining a position in the second frame corresponding to each pixel of the first frame, as in super-resolution, for example, a block of interest having a pixel of interest at the center is arranged in the first frame. A block in the second frame corresponding to the block of interest is obtained. The central position of the obtained block can be acquired as a position in the second frame corresponding to the pixel of interest in the first frame. Alternatively, pixel positions having the same positional relationship as that of all pixels (or several pixels near the center) in the block of the first frame are obtained as corresponding positions in the block of the second frame. For example, the arithmetic unit 402 or DSP1 701 executes the following process.

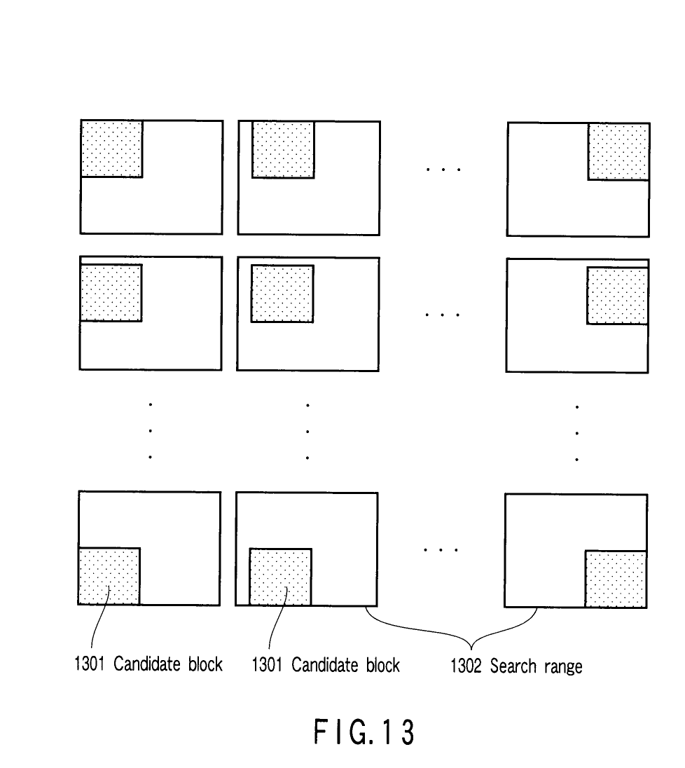

Step 1: Blocks (candidate blocks) as candidates in two frames are decided. The size and shape of a block are separately set, like 5×5 pixels. If the motion vector of each vector is to be obtained by global search, for example, as shown in FIG. 13, candidate blocks 1301 can be arranged at a search step interval (e.g., one-pixel interval) predetermined in a set search range 1302.

Step 2: A block error function value is obtained for each candidate block.

Step 3: A position where the block error function value is minimum is obtained. If the block error function value is minimum at two or more positions, any one of them can be selected. For example, a reference such as a position close to the center of the search range, a position found first, or a position found last is separately defined so that a position is selected in accordance with the reference.

The x and y (vertical and horizontal) components of the position obtained by block matching are quantized at the search step interval. To obtain a position at an accuracy higher than the quantization width, function fitting is used, which assumes the shape of an error function, estimates the parameters of the error function on the basis of the error value, and obtains the minimum position of the function, as described at the beginning of the embodiment. For SAD (L1 error) or SSD (L2 error), the above-described expressions

$$\begin{matrix}subpixel = \{ \begin{matrix}\frac{E ( - 1 ) - E ( 1 )}{2 \{ E ( 1 ) - E ( 0 ) \}} & E ( - 1 ) <= E ( 1 ) \\ \frac{E ( - 1 ) - E ( 1 )}{2 \{ E ( 1 ) - E ( 0 ) \}} & E ( - 1 ) > E ( 1 )\end{matrix} and & ( 40 ) \\ subpixel = \frac{E ( 1 ) - E ( - 1 )}{2 \{ 2 E ( 0 ) - E ( 1 ) - E ( - 1 ) \}} & ( 41 )\end{matrix}$$

are generally used. Even for another error function, a position can approximately be obtained by applying one of the expressions. Alternatively, SAD or SSD is used only in function fitting, and another error function is used in block matching.

If the quantization width of the search step is not an integer part but a fractional part, the pixel values of non-integer pixel positions in the second frame are necessary for block error calculation. At this time, values obtained by using some interpolation method (e.g., bilinear method, bicubic method, or cubic convolution method) are used as the pixel values of non-integer pixel positions. Image frames corresponding to the other frames shifted in accordance with the subpixel positional shifts are generated by pixel value interpolation.

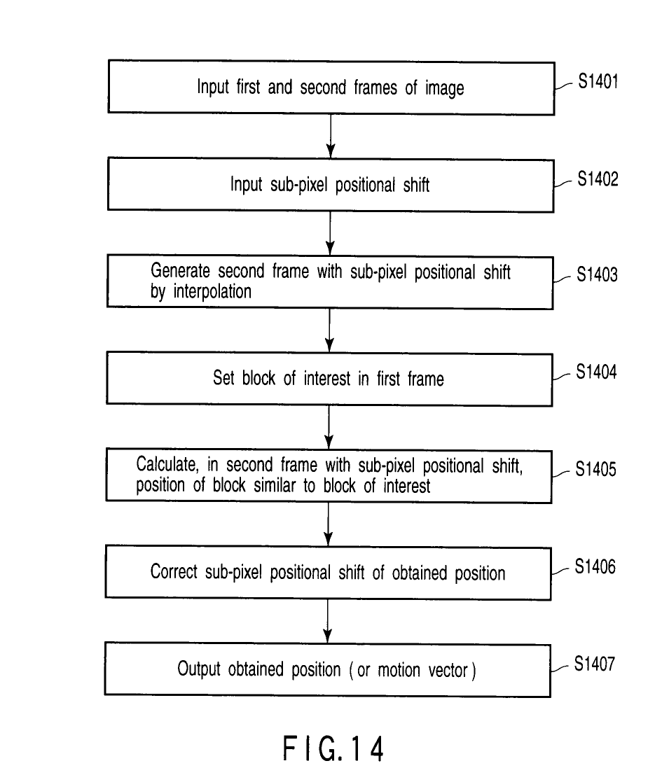

As described at the beginning of the embodiment, sampling points in an area where the aperture problem arises in an image are determined by the characteristic of the algorithm itself. When corresponding positions are obtained by block matching and function fitting in the above-described way, the sampling points are biased to the vicinity of integer pixel positions (more specifically, the vicinity of positions determined by the quantization width). This can be regarded as a bias applied in the search process. It is useful if a sampling point can be biased to another position. A method of controlling the bias of a corresponding point smaller than the quantization width (in short, the bias of the fractional component of a position or motion vector), which is caused by the aperture problem, in obtaining a motion from the first frame to the second frame, will be described with reference to FIG. 14. For example, the arithmetic unit 402 or DSP1 701 executes the following process.

Step 1 (S1401): The first frame of an image is input.

Step 2 (S1401): The second frame of the image is input.

Step 3 (S1402): A subpixel positional shift value to be biased is input. For example, (0.5,0.5) is input.

Step 4 (S1403): A phase-shifted second frame corresponding to the second frame shifted by the input subpixel positional shift value is obtained by some interpolation method (e.g., bilinear method, bicubic method, or cubic convolution method). For the cubic convolution method, see R. G. Keys, “Cubic Convolution Interpolation for Digital Image Processing”, IEEE Transactions on Acoustics, Speech, and Signal Processing, Vol. ASSP-29, No. 6, 1981.

Step 5 (S1404): A set of pixels or blocks (pixel-of-interest set) as a motion calculation target is set in the first frame.

Step 6 (S1405): For each pixel (or block) set in the first frame, a motion from the first frame to the phase-shifted second frame is obtained.

Step 7 (S1406): Each obtained motion vector (or corresponding position) indicates a motion from the first frame to the phase-shifted second frame. A motion from the first frame to the original second frame is obtained by adding the subpixel positional shift value to each motion vector.

Step 8 (S1407): The obtained motion vector is output.

The process is difficult to use for super-resolution if the position of the first frame (moving source) is not an integer pixel position. If the position of the first frame (moving source) need not be an integer, the interpolation target may be the first frame. A detailed sequence will be described below. For example, the arithmetic unit 402 or DSP1 701 executes the following process.

Step 1: The first frame of an image is input.

Step 2: The second frame of the image is input.

Step 3: A subpixel positional shift value to be biased is input. For example, (0.5,0.5) is input.

Step 4: A phase-shifted first frame corresponding to the first frame shifted by the input subpixel positional shift value is obtained by some interpolation method.

Step 5: A set of pixels or blocks (pixel-of-interest set) as a motion calculation target is set in the phase-shifted first frame.

Step 6: For each pixel (or block) set in the phase-shifted first frame, a motion from the first frame to the second frame is obtained.

Step 7: A motion from the first frame to the second frame is obtained by subtracting the subpixel positional shift from each motion vector. The moving source of the first frame is not an integer pixel position but a position obtained by subtracting the subpixel positional shift.

After steps 1 and 2, each image may undergo a filtering process using, e.g., a low-pass filter such as an averaging filter or Gaussian filter. In this embodiment, matching is performed using an interpolated image as a reference block. For this reason, the reference block is inherently not accurate and, more particularly, high-frequency components are regarded as inaccurate. However, errors caused by this problem can be reduced by applying a low-pass filter. Similarly, a filter may be applied in advance to the Lucas-Kanade method or energy minimization to be described next.

### EXAMPLE 2

### Lucas-Kanade Method

The Lucas-Kanade method obtains a position to minimize the following expression, assuming two corresponding pixels (x,y,t) and (x+Δx,y+Δy,t+Δt) between frames. Note that weighting coefficients can be applied to errors at the pixels in a block to, e.g., place importance on the center. The presence/absence of weights does not largely change the calculation method (necessary weights can be applied), and a description thereof will be omitted below.

$$E = {\sum }_{block} {( I ( x + Δ x , y + Δ y , t + Δ t ) - I ( x , y , t ) )}^{2} \qquad ( 42 )$$

A linear Taylor expansion is applied to Expression (42). The expression to be minimized for the pixel (x,y,t) is a local energy function to be described below, in which u (=Δx/Δt) and v (=Δy/Δt) represent the horizontal and vertical speeds, respectively.

$$E = \sum {( \frac{\partial I}{\partial x} u + \frac{\partial I}{\partial y} v + \frac{\partial I}{\partial t} )}^{2} \qquad ( 43 )$$

where Σ is the sum for each pixel in the block. The expression can be minimized by calculating the least-square solution. This method has no bias to a specific subpixel positional shift and cannot predict an estimated behavior in an area having the aperture problem. In an area where the aperture problem arises, the reliability of the Lucas-Kanade method is poor. On the other hand, in an area having no aperture problem, it is unnecessary to control the subpixel positional shift. For this reason, a motion is obtained first using the Lucas-Kanade method. Then, the above-described method using block matching of this embodiment is used only for pixels determined to have low reliability. As an advantage of this method, the Lucas-Kanade method, known as a highly accurate method, can be used unless the aperture problem arises.

Various methods are available to determine the reliability of the Lucas-Kanade method. For example, the reliability can be determined by the following methods.

Method 1. In calculating a least-square solution, the inverse matrix of the next matrix is obtained. Whether the inverse matrix can stably be calculated is evaluated.

$$( \begin{matrix}\sum {I}_{x} {I}_{x} & \sum {I}_{x} {I}_{y} \\ \sum {I}_{x} {I}_{y} & \sum {I}_{y} {I}_{y}\end{matrix} ) \qquad ( 44 )$$

where Ix and Iy are the partial differentials of luminance of a pixel in the block, and Σ is the sum for each pixel in the block. Whether stable calculation is possible is evaluated in the following way. For example, a value obtained by dividing the “absolute value of the value of the determinant” by the “maximum numerical value of the absolute values of the four elements of the matrix” exceeds a threshold value, the reliability is high. Otherwise, the reliability is low. Alternatively, the reliability may be determined simply based on whether the “absolute value of the value of the determinant” exceeds a threshold value.

Method 2. The reliability is determined as low if an obtained motion vector falls outside a predetermined range (e.g., a range of −32 pixels to +32 pixels in the vertical and horizontal directions).

### EXAMPLE 3

### Energy Minimization

As a further method of obtaining a motion, a method of optimizing the consistency of individual motions and the balance of smoothness of motion vectors in the entire screen is known, like the Horn-Schunck method. This method (global motion optimization) can be formulated as a problem of (approximately) minimizing, e.g., the following energy function.

$$E = \sum {ρ}_{1} ( \frac{\partial I}{\partial x} u + \frac{\partial I}{\partial y} v + \frac{\partial I}{\partial t} ) + λ \sum {ρ}_{2} ( \sqrt{\begin{matrix}{( \frac{\partial u}{\partial x} )}^{2} + \\ {( \frac{\partial v}{\partial x} )}^{2}\end{matrix}} ) \qquad ( 45 )$$

This expression is similar to that of the Lucas-Kanade method. However, this energy function is given as one function not for each pixel but for the entire image. Each Σ represents the sum for all pixels of a frame as a motion calculation target, and λ represents a separately defined weight coefficient. Two values ρ can be either an Lα error or a robust error (they need not be the same function). Formulation by Horn et al. corresponds to use of SSD as the two values ρ. The former term evaluates the consistency of individual motions (whether the luminance error can be decreased by applying the motion vectors). The latter term increases the energy value (imposes a penalty) if the motion vectors are not smooth. Each term may take another form. For example, the former term may be the block error around each pixel. The first term increases the energy value as the magnitude of a difference I(x+Δx,y+Δy,t+Δt)−I(x,y,t) between a pixel value I(x,y,t) of a pixel of interest at a time t (corresponding to the other frame in resolution conversion) and a pixel value I(x+Δx,y+Δy,t+Δt) at a time t+Δt (corresponding to the conversion target frame in resolution conversion), which is obtained by shifting the position of the pixel of interest at the time t by the motion vector becomes large. The second term increases the energy value as the magnitude of the difference between the fractional part of the motion vector and the subpixel shift becomes large.

Such energy function minimization can be done using e.g., a variational method. At this time, there is no bias to a specific subpixel positional shift, and it is impossible to predict an estimated behavior in an area having the aperture problem, like the Lucas-Kanade method.

To control a bias to a specific subpixel position, a control term is added in the following way.

$$E = \sum {ρ}_{1} ( \frac{\partial I}{\partial x} u + \frac{\partial I}{\partial y} v + \frac{\partial I}{\partial t} ) + λ \sum {ρ}_{2} ( \sqrt{\begin{matrix}{( \frac{\partial u}{\partial x} )}^{2} + \\ {( \frac{\partial v}{\partial x} )}^{2}\end{matrix}} ) + η \sum {ρ}_{3} ( \sqrt{\begin{matrix}{( u - [ u ] - Δ u )}^{2} + \\ {( v - [ v ] - Δ v )}^{2}\end{matrix}} ) \qquad ( 46 )$$

where η is a separately defined weight coefficient. Like other ρ, ρ₃ can be either an Lα error or a robust error. Note that [x] is the maximum integer smaller than x, and Δu and Δv are desired subpixel positional shifts in the horizontal and vertical directions.

It is difficult to solve such a form using a variational method that requires a function to be partially differentiated. However, it can be solved using a method of directly evaluating energy function minimization, and for example, Belief Propagation, a Graph Cuts method, or Gibbs sampler.

For example, solution using Belief Propagation is done in the following manner. First, regarding each pixel as a node of a graph (in the graph theory), a possible motion vector of each node is quantized at an appropriate interval, expressed as a discrete value, and assigned a label xᵢ={0, 1, . . . , Lᵢ−1}. The subscript “i” of the label is called a node number, or simply a node. Next, the energy function is rewritten to

$$E ( {x}_{1} , {x}_{2} , … , {x}_{n} ) = {\sum }_{i} V ( {x}_{i} ) + {\sum }_{( i , j ) ∈ N} W ( {x}_{i} , {x}_{j} ) \qquad ( 47 )$$

The following repetitive operation is executed to minimize the energy function. For example, the arithmetic unit 402 or DSP1 701 executes the following process.

Step 1: t=0 is set (t represents the number of times of message update). An initial value represented by

m^{(t)}_{p→q}(x_{q}) (48)

is given to each edge (p,q)εN. (Alternatively, all edges are initialized to 0).

Step 2: For each edge (p,q)εN,

m^{(t+1)}_{p→q}(x_{q}) (49)

is updated by the following message update expression.

$${m}^{{( t + 1 )}_{p \to q}} ( {x}_{q} ) = {min}_{{x}_{p}} ( V ( {x}_{p} ) + W ( {x}_{p} , {x}_{q} ) + {\sum }_{s} {m}^{{( t )}_{s \to p}} ( {x}_{p} ) ) \qquad ( 50 )$$

where Σs is the sum for all s that satisfy (s,p)εN and s≠q.

Step 3: t is incremented by one. If t is smaller than a predetermined repeat count T, the process returns to step 2.

Step 4: A value called “belief” given by

$${b}_{q} ( {x}_{q} ) = V ( {x}_{q} ) + {\sum }_{p} {m}^{{( T )}_{p \to q}} ( {x}_{q} ) \qquad ( 51 )$$

is obtained for each q, where Σp is the sum for all p that satisfy (p,q)εN.

Step 5: A label x_{q}={0, 1, . . . , L_{q}−1} which minimizes b_{q}(x_{q}) is selected for each q.

A motion vector for minimizing the energy can be obtained by selecting the label of each node using the above-described method.

Note that the expression to be solved by the Lucas-Kanade method corresponds to an expression of global motion optimization in which Σ is the sum in the block, and λ=0. Hence, the method of adding the term for controlling the bias to a subpixel position can be used even in the Lucas-Kanade method on the basis of the same concept.

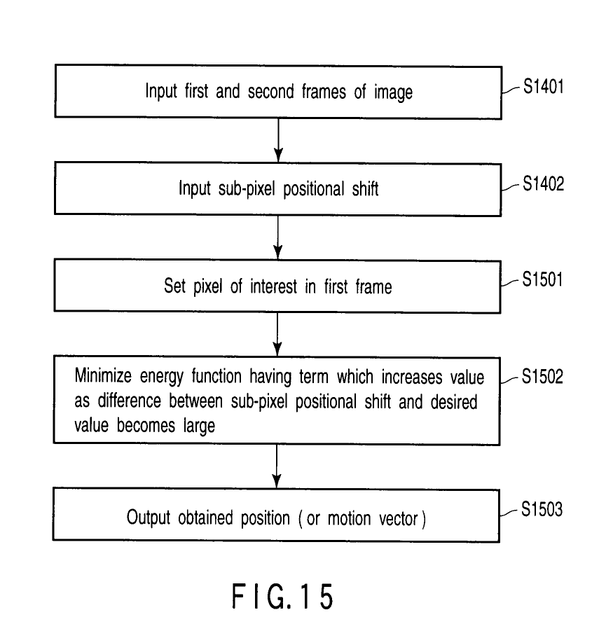

An example of global motion optimization from the first frame to the second frame or a process of the Lucas-Kanade method will be described with reference to FIG. 15. For example, the arithmetic unit 402 or DSP1 701 executes the following process.

Step 1 (S1401): The first frame of an image is input.

Step 2 (S1401): The second frame of the image is input.

Step 3 (S1402): A subpixel positional shift value (subpixel shift value) to be biased is input. For example, (0.5,0.5) is input.

Step 4 (S1501): A pixel of interest (motion calculation target pixel) is set in the first frame. In the Lucas-Kanade method, for example, one pixel or block is set. In global optimization, for example, all pixels of the screen or a separated defined area (e.g., an area corresponding to several lines of the screen) are set.

Step 5 (S1502): An optimum motion vector of the pixel of interest is obtained by energy minimization such as Belief Propagation. However, the energy function contains a term for evaluating the bias to a subpixel position.

Step 6 (S1503): The obtained motion vector is output.

### (Effect of Motion Bias)

The above-described method enables to bias a motion vector (pixel corresponding position) to a desired subpixel position in an area having the aperture problem in the combination of block matching and function fitting, the Lucas-Kanade method, or the global motion optimization method. As described above, in, e.g., super-resolution using a plurality of frames, a motion biased to

(nₓ,n_{y}),(nₓ+0.5,n_{y}),(nₓ,n_{y}+0.5),(nₓ+0.5,n_{y}+0.5) (52)

(where nₓ and n_{y} are integers)

is calculated for each of the other frames. At this time, another sampling point is obtained in an area having the aperture problem, and the same sampling point can be obtained in an area having no aperture problem at a high probability. Super-resolution using this method can improve the capability of reconstructing the high-frequency components of an image. Hence, the image processing apparatus of this embodiment can effectively obtain a sharp image especially in super-resolution.

The embodiment is also usable as a basic technology of calculating the global motion of a whole screen or each object (the motion of the whole screen is usable for, e.g., camera shake compensation, and the motion of each object is usable by, e.g., a robot to track the motion of a moving object). As one of the methods of calculating a global motion, reliable motion vectors are obtained from local motion vectors and integrated by robust estimation. At this time, if a number of unreliable motion vectors are mixed, the accuracy of the global motion obtained by estimation degrades. Positions estimated in the embodiment change only in an area where the aperture problem arises. Hence, using, e.g., block matching and function fitting, corresponding positions biased to two subpixel positions given by

(nₓ,n_{y}),(nₓ+0.5,n_{y}+0.5) (53)

are calculated. Motion vectors which do not match the obtained vectors (i.e., have a vector difference outside a predetermined range) are discarded. Robust estimation is executed for the remaining motion vectors. This prevents unreliable motion vectors from mixing and enables to accurately obtain the global motion.

According to the above-described embodiment, it is possible to intentionally control the interval of selected sampling points to be smaller than the pixel interval at the output resolution in an area where the aperture problem arises. This enables to reproduce the high-frequency components of pixel values in super-resolution based on the obtained corresponding sampling points and obtain a sharp image having a resolution higher than that of the input image.

The flow charts of the embodiments illustrate methods and systems according to the embodiments of the invention. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a first receiving unit configured to receive a plurality of frames of an image containing pixel values;
a first setting unit configured to set one of the frames as a reference frame;
a second setting unit configured to set, of the frames received by the first receiving unit, one frame other than the reference frame as an other frame;
a first storage unit configured to store at least one subpixel shift value that is a preset real value; and
an estimation unit configured to estimate a fractional part of a position of a corresponding point corresponding to a pixel of the other frame to readily select a value closer to the subpixel shift value.

2. An image processing apparatus comprising:
a first receiving unit configured to receive a plurality of frames of an image containing pixel values;
a first setting unit configured to set one of the frames as a reference frame;
a second setting unit configured to set the reference frame as an other frame;
a first storage unit configured to store at least one subpixel shift value that is a preset real value; and
an estimation unit configured to estimate a fractional part of a position of a corresponding point corresponding to a pixel of the other frame to readily select a value closer to the subpixel shift value.

3. The apparatus according to claim 2, wherein the second setting unit is configured to set a plurality of frame included in the reference frame as other frames.

4. The apparatus according to claim 1, wherein the estimation unit comprises:
a generation unit configured to generate a temporary reference frame by shifting the reference frame by the subpixel shift value using pixel value interpolation;
a third setting unit configured to set a position of interest in the other frame;
a fourth setting unit configured to set a block of interest based on the position of interest;
a first calculation unit configured to calculate a first position in the temporary reference frame, the first position having a pixel value pattern similar to a pixel value pattern in the block of interest; and
an acquisition unit configured to acquire, as the corresponding point, a second position in the reference frame corresponding to the position of interest by correcting the first position by the subpixel shift value.

5. The apparatus according to claim 2, wherein the estimation unit comprises:
a generation unit configured to generate a temporary reference frame by shifting the reference frame by the subpixel shift value using pixel value interpolation;
a third setting unit configured to set a position of interest in the other frame;
a fourth setting unit configured to set a block of interest based on the position of interest;
a first calculation unit configured to calculate a first position in the temporary reference frame, the first position having a pixel value pattern similar to a pixel value pattern in the block of interest; and
an acquisition unit configured to acquire, as the corresponding point, a second position in the reference frame corresponding to the position of interest by correcting the first position by the subpixel shift value.

6. The apparatus according to claim 1, further comprising:
a second receiving unit configured to receive an output resolution;
a second storage unit configured to store a point spread function which calculates a first pixel value of a resolution of the reference frame from a second pixel value corresponding to the output resolution; and
a second calculation unit configured to calculate a third pixel value of the reference frame at the output resolution using a fourth pixel value at the corresponding point as a corresponding pixel value of the other frame.

7. The apparatus according to claim 2, further comprising:
a second receiving unit configured to receive an output resolution;
a second storage unit configured to store a point spread function which calculates a first pixel value of a resolution of the reference frame from a second pixel value corresponding to the output resolution; and
a second calculation unit configured to calculate a third pixel value of the reference frame at the output resolution using a fourth pixel value at the corresponding point as a corresponding pixel value of the other frame.

8. The apparatus according to claim 6, wherein the estimation unit comprises:
a generation unit configured to generate a temporary reference frame by shifting the reference frame by the subpixel shift value using pixel value interpolation;
a third setting unit configured to set a position of interest in the other frame;
a fourth setting unit configured to set a block of interest based on the position of interest;
a first calculation unit configured to calculate a first position in the temporary reference frame, the first position having a pixel value pattern similar to a pixel value pattern in the block of interest; and
an acquisition unit configured to acquire, as the corresponding point, a second position in the reference frame corresponding to the position of interest by correcting the first position by the subpixel shift value.

9. The apparatus according to claim 8, wherein the first calculation unit comprises:
a fifth setting unit configured to sequentially set, in the reference frame, a plurality of candidate blocks each of which is a block having the same size as the block of interest;
a third calculation unit configured to calculate, as a sum of error values, a first block error by obtaining, for each pixel in the block of interest, an error value which is a value obtained by inputting a difference between a pixel value in the block of interest and a pixel value in the candidate block corresponding to the pixel value into an error function for obtaining an error between pixel values;
a selection unit configured to select, from the candidate blocks, a candidate block having a minimum block error as an optimum candidate block;
a fourth calculation unit configured to calculate a second block error for at least one neighboring candidate block set near the optimum candidate block;
a fifth calculation unit configured to calculate a coefficient of the error function based on the first block error and the second block error; and
a sixth calculation unit configured to calculate, as the position in the reference frame, a position where the error function including the calculated coefficient is minimum.

10. The apparatus according to claim 1, wherein the estimation unit comprises:
a sixth setting unit configured to set an energy function including a term which increases a first energy value as a magnitude of a difference between a pixel value of a pixel of interest in the other frame and a pixel value at a position to which a pixel of interest in the reference frame is shifted by a motion vector becomes large, and a term which increases a second energy value as a magnitude of a difference between a fractional part of the motion vector and the subpixel shift value becomes large; and
a seventh calculation unit configured to calculate, as the corresponding point, a motion vector which minimizes the energy function.

11. The apparatus according to claim 2, wherein the estimation unit comprises:
a sixth setting unit configured to set an energy function including a term which increases a first energy value as a magnitude of a difference between a pixel value of a pixel of interest in the other frame and a pixel value at a position to which a pixel of interest in the reference frame is shifted by a motion vector becomes large, and a term which increases a second energy value as a magnitude of a difference between a fractional part of the motion vector and the subpixel shift value becomes large; and
a seventh calculation unit configured to calculate, as the corresponding point, a motion vector which minimizes the energy function.

12. An image processing method comprising:
receiving a plurality of frames of an image containing pixel values;
setting one of the frames as a reference frame;
setting, of the received frames, one frame other than the reference frame as an other frame.
storing, in a first storage unit, at least one subpixel shift value that is a preset fractional value; and
estimating a fractional part of a position of a corresponding point corresponding to a pixel of the other frame to readily select a value closer to the subpixel shift value.
